(19) United States
(12) Patent Application Publication
(10) Pub. No.: US 2025/0338344 A1
(43) Pub. Date: Oct. 30, 2025

(54) EXTENDED REALITY (XR) DEVICE NOTIFICATIONS FOR WIRELESS CONNECTIVITY ADJUSTMENT

(71) Applicant: QUALCOMM Incorporated, San Diego, CA (US)

(72) Inventors: Balaji Srinivasan THIRUVENKATACHARI, Bengaluru (IN); Sankara Subramaniam B S, Bengaluru (IN); Subramanian ANANTHARAMAN, Bangalore (IN); Rohit KAPOOR, Bangalore (IN)

(21) Appl. No.: 18/644,487

(22) Filed: Apr. 24, 2024

(51) Int. Cl. H04W 76/25; H04W 24/10; H04W 48/18

(52) U.S. Cl. CPC H04W 76/25; H04W 24/10; H04W 48/18

(57) ABSTRACT

Certain aspects of the present disclosure provide techniques for adjusting the wireless connectivity of an extended reality (XR) device. A method generally includes obtaining operation information for a wireless communications environment; generating, based on the operation information, a first notification for a first XR device operating within the wireless communications environment, wherein the first notification indicates one or more actions to adjust wireless connectivity of the first XR device within the wireless communications environment; and communicating the first notification.

### INTRODUCTION

### Field of the Disclosure

Aspects of the present disclosure relate to wireless communications, and more particularly, to techniques for adjusting the wireless connectivity of an extended reality (XR) device.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by an apparatus. The method includes obtaining operation information for a wireless communications environment; generating, based on the operation information, a first notification for a first extended reality (XR) device operating within the wireless communications environment, wherein the first notification indicates one or more actions to adjust wireless connectivity of the first XR device within the wireless communications environment; and communicating the first notification.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5 depicts an example system that provides an extended reality (XR) experience to a user.

FIG. 6 depicts an example workflow for generating output notification(s) on an XR device to trigger wireless connectivity adjustment.

FIGS. 7A-7D depict example options for output notification generation on an XR device.

FIG. 8 depicts example generation of an output notification on an XR device used to provide directional assistance.

FIG. 9 depicts example generation of an output notification on an XR device used to provide positional assistance.

FIGS. 10A-10B depict example generation of an output notification on an XR device used to provide geographical fencing assistance.

FIG. 11 depicts example generation of an output notification on an XR device used to provide network selection assistance.

FIG. 12 depicts a method for wireless communications.

FIG. 13 depicts aspects of an example communications device.

### DETAILED DESCRIPTION

Aspects of the present disclosure provide apparatuses, methods, processing systems, and computer-readable mediums for adjusting the wireless connectivity of an extended reality (XR) device in a wireless communications environment.

XR is an umbrella term encompassing immersive technologies such as virtual reality (VR), augmented reality (AR), and mixed reality (MR). XR creates either fully virtual, immersive environments or blends those virtual landscapes and features with the “real” world to enhance user experiences in a wide range of contexts (e.g., gaming, healthcare, manufacturing, education, retail, etc.). For example, AR augments the real world of a user by enabling interaction with a virtual world and/or virtual content. VR places a user inside a virtual environment generated by a computer. Further, MR merges the real and virtual worlds. With high levels of interactivity and immersion, XR may deliver engaging, untethered virtual experiences to users.

XR may need high performance wireless connectivity to deliver immersive environments and real-time behavior, and may be intolerant of low performance wireless connectivity. For example, seamless and ubiquitous connectivity to the internet and/or cloud services may help XR to reach its full potential. Wireless connectivity with low latency, high reliability, low power consumption, and/or high capacity may be important to meet service requirements for XR.

In a real-world environment, however, providing low latency, high data rates, and/or ultra-reliable connectivity to XR devices, such as at all times, is a technically challenging task. For example, a wireless communications network, providing connectivity to XR devices, may suffer from network congestion, bandwidth saturation, and/or poor hardware performance (among others) at some point when the XR devices are connected. As such, the network may struggle to process and send high data volume with reduced latency, which may result in poor XR experiences at the XR devices.

For example, VR-based applications may be highly interactive, and one important metric for these applications may include motion-to-photon-delay (MPD). MPD is the delay from a VR user's head movement to the time at which an image gets updated on a VR display associated with the VR user. If the MPD is larger than 20 ms, a VR user may feel spatially disoriented and/or dizzy, often referred to as VR sickness. The delay may also cause the VR user's brain to reject the virtual world, causing them to lose immersion. As such, in cases where a wireless communications network is congested and suffers from high latency, this MPD requirement may not be met. Thus, the VR device may be unable to generate a fully immersive experience for the VR user.

Further, in certain aspects, the connectivity experienced by an XR device may be based on a geographical location of the XR device in a wireless communications environment. For example, an XR device connected to and communicating XR traffic with another wireless device may experience higher latency communication when the XR device is further away from the wireless device than when the XR device is located near the wireless device. Location of the XR device in the wireless communications environment may be controlled by a user of the XR device. As such, in some cases, the wireless communications network may have little to no control over the level of latency, data rates, and/or connectivity experienced by the XR device. This may present a technical challenge in ensuring that key service requirements for the XR device are met to attain positive and effective XR experiences for users.

Certain aspects described herein may overcome the aforementioned technical challenges and improve upon the state of the art. For example, certain aspects described herein provide techniques for outputting, and/or initiating or causing the output of, notification(s) (also referred to herein as “output notification(s)”) on an XR device based on real-time, or near real-time, measurements of beam or wireless connection conditions, XR device location, or the like. The output notification(s) may include visual, audio, and/or haptic output(s) produced on the XR device. The output notification(s) may be produced to indicate or suggest the performance of one or more actions for adjusting the wireless connectivity of the XR device. These suggestion(s) may help to ensure that wireless connectivity for the XR device meets key service requirements, which may be important for generating fully immersive XR experiences at the XR device. For example, the suggestion(s) may be used to trigger a user of the XR device to perform the indicated or suggested action(s) to maintain and/or improve the wireless connectivity of the XR device.

Example action(s) indicated by an output notification may include (1) an action to move in a particular direction (e.g., move left, right, etc.) and/or (2) an action to move to a particular position (e.g., move closer to a connected wireless device). Other example action(s) indicated by an output notification may include (3) an action to stay within a geographical boundary (e.g., where the geographical boundary identifies an area where quality of service (QOS) requirements for the XR device may be met), (4) an action to select and/or switch a connectivity technology used by the XR device (e.g., switch to using WiFi, cellular, Bluetooth, etc.), and/or (5) any other actions that may affect a wireless connectivity of the XR device.

In certain aspects, an output notification may be produced on an XR device based on operation information associated with a wireless communications environment where the XR device is operating. For example, in certain aspects, the XR device may evaluate whether a wireless connectivity of the XR device needs to be adjusted based on operation metric(s) obtained for the wireless communications environment. In some cases, the XR device may obtain the operation metric(s) itself. In some cases, the XR device may obtain the operation metric(s) from one or more other wireless devices in the wireless communications environment. In certain aspects, if the XR device determines that the wireless connectivity of the XR device needs to be adjusted, such as to meet QoS requirements for the XR device, then the XR device may produce one or more output notifications on the XR device. The output notification(s) may be used to prompt a user to take action to adjust the wireless connectivity.

In certain other aspects, one or more other wireless devices may evaluate whether a wireless connectivity of the XR device needs to be adjusted based on operation metric(s) associated with the wireless communications environment. If wireless connectivity of the XR device is determined to be adjusted, then one of the other wireless device(s) may generate a notification. The notification may indicate one or more actions to adjust wireless connectivity of the XR device within the wireless communications environment. This notification may be communicated to the XR device. In response to receiving this notification, the XR device may produce output notification(s) on the XR device.

Example operation information associated with the wireless communications environment may include channel measurement(s), interference measurement(s), transmission data rate(s), packet error rate(s), power measurement(s), network availability information, latency information, operating band information, signal strength information, frequency hopping co-existence information, beam tracking information, a power state of the XR device, and/or information about pending data for transmission. It should be noted, however, that the above-described types of operation information include only example operation information types that may be obtained for the wireless communications environment. The above-described types of operation information are not exhaustive, and other kinds of operation information may be obtained, which provide information about the wireless communications environment where the XR device is operating.

The XR device output notifications, produced according to the techniques described herein, may have the beneficial technical effect of improving and/or maintaining a wireless connection of the XR device. Thus, key service requirements for XR may be consistently achieved to deliver immersive environments and/or real-time behavior to users. This may in turn improve user experience and/or the effectiveness of an XR experience provided via the XR device.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

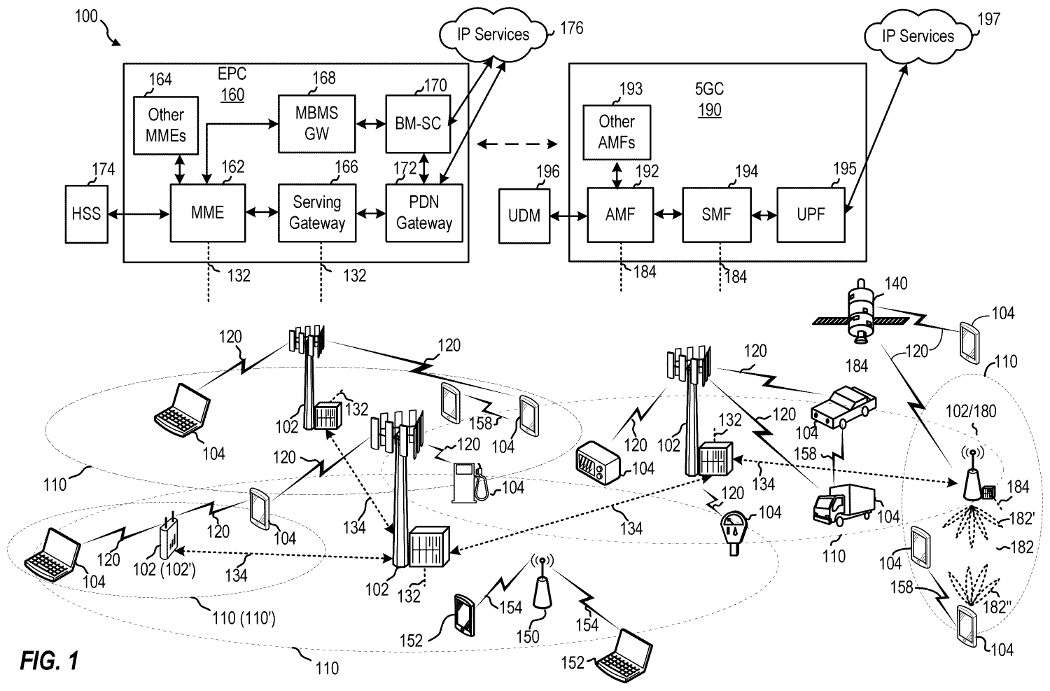

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to herein as non-terrestrial network entities), such as satellite 140 and/or aerial or spaceborne platform(s), which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

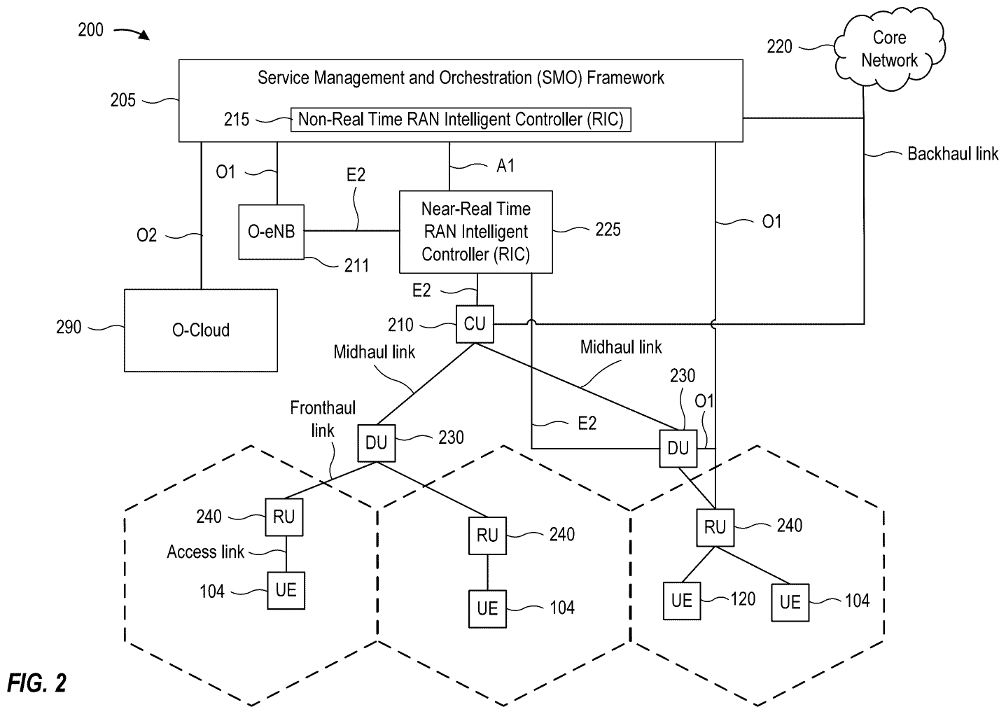

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHZ-7125 MHz, which is often referred to (interchangeably) as “Sub-6 GHz”. Similarly, 3GPP currently defines Frequency Range 2 (FR2) as including 24,250 MHZ-71,000 MHZ, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

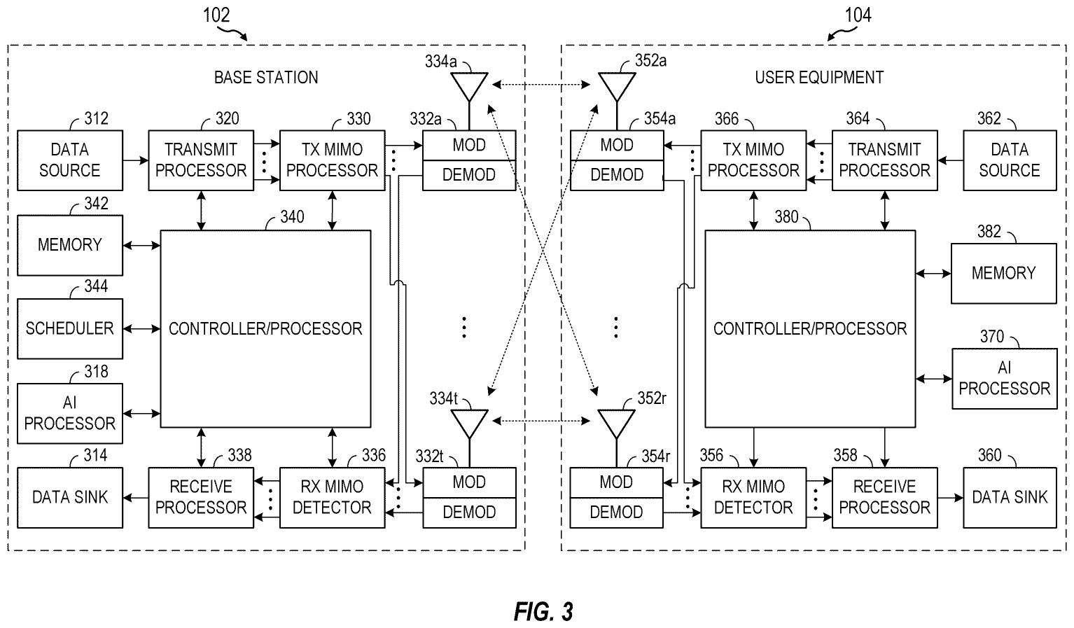

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications. Note that the BS 102 may have a disaggregated architecture as described herein with respect to FIG. 2.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., non-line of sight positioning prediction). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

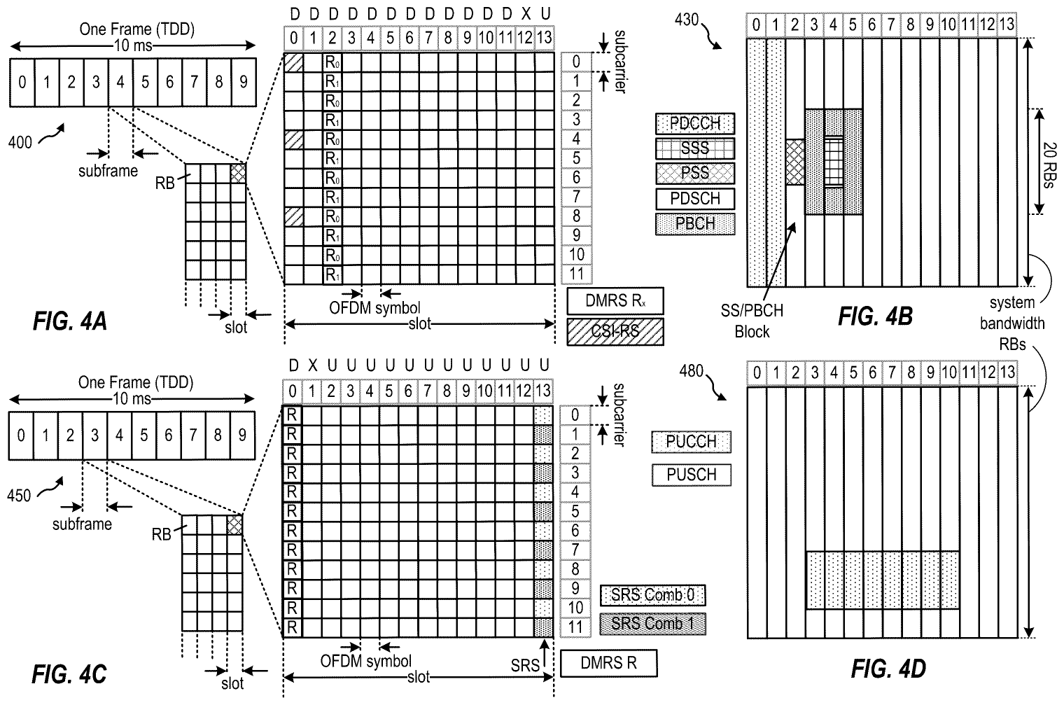

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 2^{μ}×15 kHz, where u is the numerology 0 to 6. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to XR

XR is the umbrella term for technologies that act as interfaces between the real (e.g., physical) and virtual worlds. For example, XR technologies can combine physical environments from the real world and virtual environments or content to provide a user with an XR experience. An XR experience may allow the user to interact with a real or physical environment enhanced and/or augmented with virtual content. As another example, an XR experience may allow a user to interact with a completely virtual environment. The term XR may encompass VR, MR, and AR technologies. Each of these forms of XR may offer a different level of immersion and/or interaction to allow users to experience and/or interact with immersive virtual environments and/or content.

For example, VR may completely immerse a user in a virtual world, usually using a head-mounted display (HMD) and/or projections that encapsulate the user with a full visual experience of a virtual world. By tracking the motions and position of the user, the motions and position of the user may be mimicked in the virtual world giving the perception of full immersion.

AR, on the other hand, is the integration of digital information with a user's physical environment in real time. Unlike VR, which creates a completely artificial environment for the user, AR may enable a user to experience a real world environment with generated perceptual information overlaid on top of it. AR delivers visual elements, sound, and/or other sensory information to the user through a device, such as a smartphone, smart glasses, and/or an AR headset. This information is overlaid onto the device to create an interwoven and immersive experience where digital information alters the user's perception of the physical world. The overlaid information can be added to and/or mask part of a physical environment.

While VR immerses users in a simulated three-dimensional (3D) environment, and AR layers elements of a virtual world on real-world surroundings, MR combines the two to create an experience where users can interact with both the virtual and physical worlds more seamlessly. For example, combining aspects of VR and AR allows for objects and/or actions from the real world to affect simulated objects in an MR environment.

The use of XR technology is often associated with industries such as gaming and/or entertainment. However, XR technology has also been implemented to enhance user experiences in a wide range of contexts, such as healthcare, education, and/or retail, to name a few. For example, XR may be used to teach workers how to assemble doors for airplanes, let medical students practice in an operating room setting, and/or allow for virtual try-ons in retail to enable more informed purchases, among many other use cases.

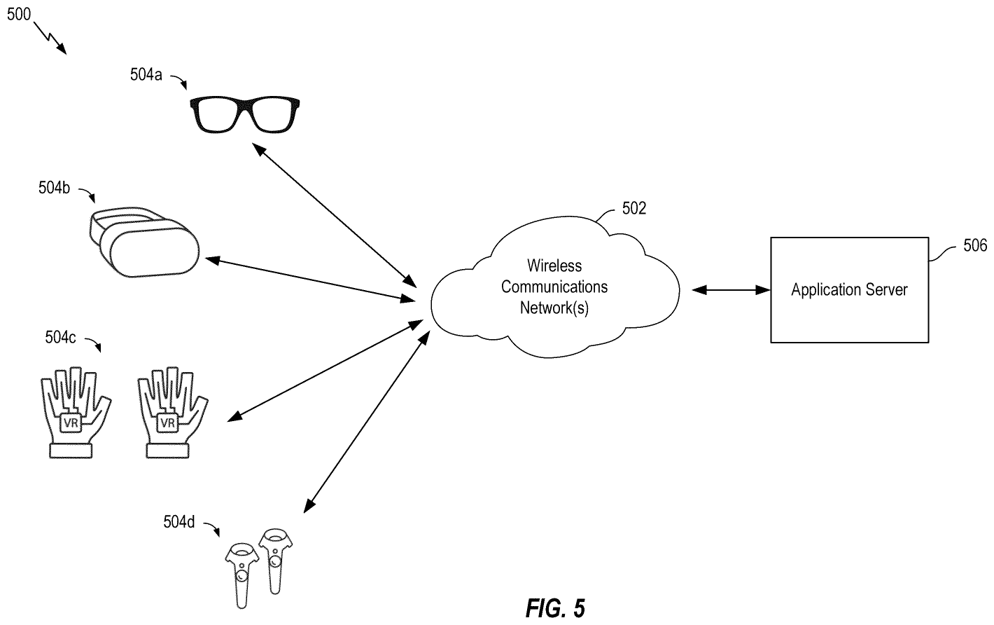

FIG. 5 depicts an example system 500 that may provide an XR experience to one or more users. As shown, system 500 includes XR devices 504a-d, an application server 506, and wireless communications network(s) 502.

The XR devices 504a-d may be or include XR glasses 504a, an XR headset 504b, XR gloves 504c, XR controllers 504d, one or more sensors (not shown), an XR BS (not shown), and/or one or more other devices. The XR devices 504a-d may be configured to engage in communications of a service, such as XR traffic. The XR devices 504a-d may be an example of one or more UEs that communicate the traffic (e.g., such as multi-modal traffic) of one or more users. In some cases, one or more of the XR devices 504a-d may communicate traffic of a single user.

In this example, the XR devices 504a-d may communicate with an application server 506 via wireless communications network(s) 502. The application server 506 may be or include an XR application server that hosts certain XR content for the XR devices 504a-d. The application server 506 may be or include one or more computing devices including, for example, a server, a computer (e.g., a laptop computer, a tablet computer, a personal computer (PC), a desktop computer, etc.), a virtual device, or any other electronic device or computing system capable of hosting one or more XR sessions.

The traffic may include various traffic streams associated with a service (e.g., an XR session) including, for example, pose traffic, control traffic, sensor traffic, haptic traffic, video traffic, and/or audio traffic. As an example of some traffic involved in cloud-based AR rendering, the application server 506 may obtain video frames captured at the XR headset 504b along with pose information and/or control information. The application server 506 may overlay (or determine where to overlay) computer generated content in the video frames, such as textual information or computer generated visualizations. The application server 506 may send, to the XR headset 504b, the augmented video frames and/or information to render the augmented video frames at the XR headset 504b. In some cases, the application server 506 may send other traffic streams to the XR devices 504a-d, such as audio traffic, haptic feedback information, etc.

Wireless communications network(s) 502 may facilitate communications and/or data exchanges between different system components and the different entities associated with system 500, including between at least XR devices 504a-d and application server 506. The wireless communications network(s) 502 may include a wireless local area network (WLAN), a wireless personal area network (WPAN), a wireless wide area network (WWAN), or the like.

A WLAN is a type of local area network (LAN) that connects local network nodes using radio technology rather than wired connection. A WLAN may include a wireless network configured for communications according to an Institute of Electrical and Electronics Engineers (IEEE) standard such as one or more of the 802.11 standards, etc. For example, WiFi, which refers to a suite of wireless communication protocols defined by IEEE 802.11 (e.g., IEEE 802.11ac and 802.11ax), is one type of WLAN. WiFi operates on the 2.4 GHz and 5 GHz frequency bands and is widely used for local area networking and internet access. WiFi is commonly found in homes, businesses, and public spaces, providing wireless connectivity for a wide range of devices such as smartphones, laptops, and smart home devices, for example.

WiGig, which is defined by the IEEE 802.11ad wireless networking standard, is another type of WLAN. WiGig is a wireless technology that operates on the 60 GHz frequency band and provides high-speed wireless communication over short distances. WiGig is designed to complement and extend the capabilities of traditional WiFi by offering multi-gigabit data rates for applications such as XR.

A WPAN is a small-scale wireless network that requires little or no infrastructure and operates within a short range. A WPAN may be created using Bluetooth, infrared, Z-wave, or any similar wireless technologies. For example, Bluetooth is a wireless technology that allows devices to communicate over short distances (e.g., up to 10 meters (m)) using low-power radio waves. Bluetooth enables short-range data and voice communication between devices, such as smartphones, headphones, speakers, laptops, printers, and/or medical equipment, among others. Bluetooth operates in the 2.4 GHz unlicensed industrial, scientific, and medical (ISM) frequency band, which helps to provide a good balance between range and throughput.

While WLAN and WPAN primarily use Wi-Fi and Bluetooth technology, respectively, a WWAN uses cellular technology. For example, a WWAN may include an NR system (e.g., a 5G NR network), an E-UTRA system (e.g., a 4G network), a UMTS (e.g., a Second Generation (2G) or Third Generation (3G) network), a code division multiple access (CDMA) system (e.g., a 2G/3G network), any future WWAN system, or any combination thereof. An example WWAN may include wireless communications network 100 depicted and described herein with respect to FIG. 1.

XR devices 504a-d connected to wireless communications network(s) 502 may communicate among each other, with application server 506, and/or with any of various wireless devices via any of various radio access technologies (RATs), where a wireless device may refer to a wireless communications device. The RATs may include, for example, WWAN communications (e.g., E-UTRA and/or 5G NR), WLAN communications (e.g., IEEE 802.11), WPAN communications (e.g., short-range communications, such as Bluetooth), non-terrestrial network (NTN) communications, etc. The wireless devices may include, for example, UEs (e.g., such as UEs 104 described above with respect to FIGS. 1 and 3), network entities (e.g., such as BSs 102 of FIGS. 1 and 3, or disaggregated base stations as discussed with respect to FIG. 2), wireless APs, wireless STAs, Bluetooth-enabled devices, and/or the like. The wireless devices may also include midhaul and/or backhaul network elements such as, intermediary RAN elements, operator/cloud network elements, WLAN controllers, and/or the like.

As an illustrative example, XR glasses 504a may be capable of connecting to the Internet via WiFi, a cellular service provider, and/or Bluetooth. Wi-Fi works by connecting XR glasses 504a to a wireless router (e.g., a wireless AP), which then connects to the Internet. A cellular connection enables XR glasses 504a to connect to the Internet by accessing BSs that provide communications coverage in different cells (e.g., as shown in FIG. 1). Bluetooth enables XR glasses 504a to connect to wireless devices through a process referred to as “pairing,” which is a form of information registration for linking wireless devices. XR glasses 504a may switch between WiFi, cellular, and Bluetooth communications to communicate XR traffic with any of various wireless devices.

As discussed, providing ubiquitous and seamless connectivity to XR devices 504a-d is technically challenging in a real-world environment. For example, network congestion, bandwidth saturation, and/or malfunctioning of hardware device(s), among others, may be inevitable in wireless communication network(s) 502, thus continuously providing “near-perfect” connectivity to XR devices 504a-d may be difficult to achieve.

Further, how seamless an XR experience is for a user may be based on a geographic location of an XR device 504 providing the experience to the user. For example, network latency experienced by XR device 504 may depend on a distance between XR device 504 and application server 506, which sends XR content to XR device 504 for rendering. As another example, packet loss experienced by XR device 504 may depend on a number of other wireless devices near XR device 504 and, such as an amount of interference caused to XR device 504 by such devices. Location of XR device 504 is generally controlled by a user of XR device 504. This may present a technical problem, as the user may be unware of a location that provides sufficient connectivity for receiving the XR experience.

Accordingly, latency and/or data rates experienced by XR applications, which may depend on very low levels of latency and high data rates, may not always be sufficient to generate fully immersive experiences. As such, user experience may be negatively affected and overall effectiveness of using such XR applications may be reduced.

### Aspects Related to XR Device Notifications Used to Trigger Wireless Connectivity Adjustment

Such as to overcome the aforementioned technical problems and improve upon the state of the art, aspects described herein introduce techniques for adjusting the wireless connectivity of an XR device. For example, the aspects described herein provide techniques for outputting, and/or initiating or causing the output of, notification(s) (also referred to herein as “output notification(s)”) on an XR device based on operation information associated with a wireless communications environment where the XR device is operating. The output notification(s) may be user notification(s) used to communicate information to a user of the XR device. For example, the output notification(s) may provide a user of the XR device with (e.g., real-time) information that may assist the user in adjusting the wireless connectivity of the XR device within the wireless communications environment. As such, the output notification(s) may help to ensure that the wireless connectivity of the XR device meets user and/or application QoS requirements. For example, the output notification(s) may be used to reduce latency, reduce packet loss, and/or increase a transmission rate of data to the XR device such that XR experiences, provided by the XR device to a user, are perceived as “real.” Accordingly, user experience may be enhanced and/or effectiveness of the XR experience may be improved.

In certain aspects, the output notification(s) on the XR device are generated by the XR device based on operation information obtained by the XR device. In certain aspects, the XR device may obtain the operation information itself by taking one or more measurements within the wireless communications environment. In certain aspects, the operation information may be collected by one or more other devices in the wireless communications environment and sent to the XR device for processing. The XR device may determine to generate the output notification(s) based on processing the operation information. Processing the operation information may include comparing the operation information to one or more thresholds.

In certain other aspects, the output notification(s) on the XR device are generated based on one or more notifications communicated to the XR device from other wireless device(s) within the wireless communications environment. The notification(s) may be generated by the other wireless device(s) based on operation information associated with the wireless communications environment.

Example operation information associated with the wireless communications environment may include channel measurement(s), interference measurement(s), transmission data rate(s), packet error rate(s), power measurement(s), latency information, operating band information, signal strength information, frequency hopping co-existence information, beam tracking information, a power state of the XR device, and/or information about pending data for transmission.

In certain aspects, the notification(s) on the XR device may indicate or suggest that a user of the XR device perform one or more actions to adjust the wireless connectivity. The suggested action(s) may provide directional assistance, such as a suggestion to move the XR device to the left or to the right. The suggested action(s) may provide positional assistance, such as a suggestion to move the XR device to a particular position (e.g., a position closer to a wireless device communicating with the XR device). The suggested action(s) may provide geographical fencing assistance, such as a suggestion to stay within a geographical boundary. The suggested action(s) may provide network selection assistance, such as a suggestion to select and/or switch to a particular connectivity technology (e.g., select and/or switch to using WiFi for wireless communication).

In certain aspects, the notification(s) on the XR device may be provided as a visual output, an audio output, and/or a haptic output. For example, the XR device may display text on an XR device (e.g., such as one of XR device 504a-d in FIG. 5). The text may indicate suggested action(s) of a user of the XR device to trigger such action(s) by the user. As another example, the XR device may generate audio output, such as a sound associated with a particular action (e.g., a chime sound may be associated with an action to move left while a trumpet sound may be associated with an action to move right) and/or speech output indicating the particular action (e.g., “Please move left to improve performance.”). As another example, the XR device may generate various vibrations associated with different actions (e.g., one vibration may be associated with an action to move the XR device to the left while two vibrations may be associated with an action to the XR device to the right).

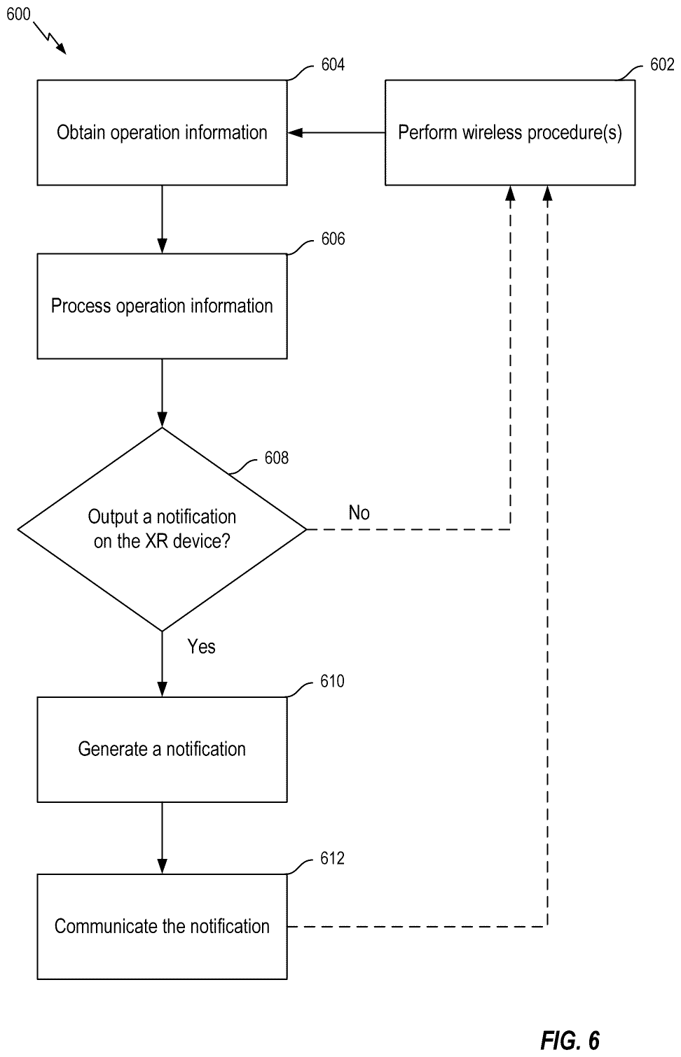

FIG. 6 depicts an example workflow for generating output notification(s) on an XR device (e.g., such as one of XR devices 504a-d depicted and described with respect to FIG. 5) to trigger wireless connectivity adjustment. In certain aspects, operations at blocks 602-612 in workflow 600 may be performed on the XR device to generate an output notification on the XR device. In certain other aspects, the performance of operations at blocks 602-612 in workflow 600 may be distributed across various (e.g., two or more) wireless devices to generate an output notification on the XR device. The other wireless device(s) may include other XR device(s), UE(s) (e.g., such as UE(s) 104 described above with respect to FIGS. 1 and 3), network entity (ies) (e.g., such as BS(s) 102 of FIGS. 1 and 3, or disaggregated base station(s) as discussed with respect to FIG. 2), wireless AP(s), wireless STA(s), Bluetooth-enabled device(s), intermediary RAN element(s), operator/cloud network element(s), WLAN controller(s), and/or the like.

Workflow 600 begins, at block 602, with performing one or more wireless procedures. In certain aspects, the wireless procedure(s) may include taking one or more measurements within the wireless communications environment, such as channel measurement(s), latency measurement(s), power measurement(s) for the XR device and/or one or more other device(s) in the wireless communications environment, etc. In certain aspects, the wireless procedure(s) may include collecting information for the wireless communications environment, such as operating band information, frequency hopping co-existence information, information about pending data for transmission (e.g., to the XR device), etc. In certain aspects, the wireless procedure(s) my include scanning the wireless communications environment. In certain aspects, the wireless procedure(s) are continuously or periodically performed, at 602. In certain aspects, the wireless procedure(s) are performed at 602 based on one or more dynamic triggers.

Based on performing the wireless procedure(s), operation information for the wireless communications environment may be obtained at block 604. As described herein, the operation information may include channel measurement(s), interference measurement(s), transmission data rate(s), packet error rate(s), power measurement(s), latency information, operating band information, signal strength information, frequency hopping co-existence information, beam tracking information, a power state of the XR device, and/or information about pending data for transmission, among others.

Workflow 600 then proceeds, at block 606, with processing the operation information. Processing the operation information may include comparing at least part of the operation information to one or more thresholds. The threshold(s) may be static, semi-static, and/or dynamic threshold(s) (e.g., key performance indicator (KPI) threshold(s)). Processing the operation information may be performed at block 606 to evaluate whether wireless connectivity of the XR device needs to be adjusted and thus, one or more output notifications need to be produced on the XR device. For example, operation information obtained for the wireless communications environment may include packet loss rate information. If, when processing the packet loss rate information, it is determined that the packet loss rate does not satisfy (e.g., is greater than) a threshold packet loss rate for the wireless communications environment, then one or more output notification(s) may need to be produced on the XR device to adjust the current wireless connectivity of the XR device.

Workflow 600 proceeds, at block 608, with determining whether a notification needs to be output on the XR device. In certain aspects, if the operation information does not satisfy at least one threshold, then a notification may need to be output at the XR device. Alternatively, if the operation information satisfies all threshold(s) considered during processing (e.g., which may be less than all available thresholds to consider), then a notification may not need to be output on the XR device.

If no notification is needed, then workflow 600 returns to block 602 to perform wireless procedure(s) in wireless communications environment. Re-performing wireless procedure(s) again may be useful to monitor the change in operation information for the wireless communication environment. For example, wireless connectivity at the XR device my change over time. As such, by obtaining operation information for the wireless communications environment, over time, this change in wireless connectivity for the XR device may be monitored such that appropriate action may be taken to mitigate poor connectivity, e.g., by generating one or more output notifications.

If a notification needs to be output on the XR device, workflow 600 proceeds, at blocks 610 and 612, with generating a notification and communicating the notification, respectively. The notification may be based on the operation information. The notification may indicate action(s) to adjust wireless connectivity of the XR device.

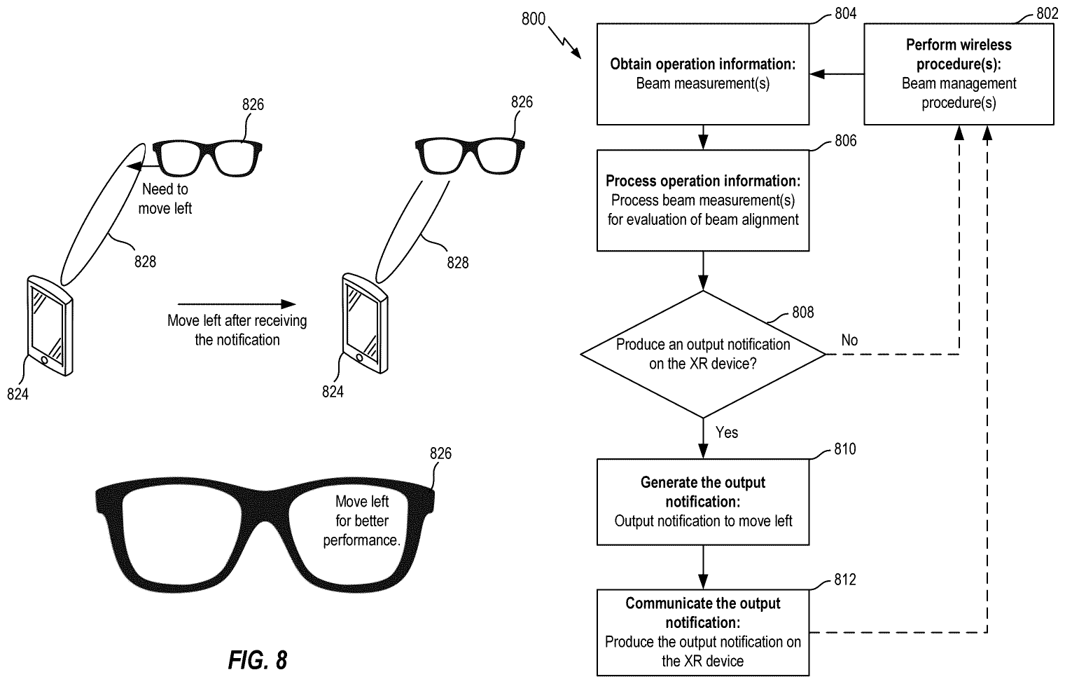

As an illustrative example, the XR device may be communicating with a BS in the wireless communications environment. The XR device may be located a significant distance away from the BS. Reference signal received power (RSRP) measured at the XR device, when communicating with the BS, may be less than a threshold RSRP, thereby indicating poor signal quality between the XR device and the BS. The poor signal quality may be attributed to the distance between the XR device and the BS. As such, a notification generated at block 610 may include a notification indicating that the XR device is suggested to move towards/closer to the BS for improved communication. Additional examples related to the generation of notification(s) based on operation information associated with a wireless communications environment are depicted and described with respect to FIGS. 8-11.

As described herein, operations of workflow 600 may be (1) distributed across two or more devices, including at least the XR device, or (2) performed at the XR device only. In cases where all operations, depicted at blocks 602-612 in workflow 600, are only performed at the XR device, then communicating the notification at block 612, may include producing an output notification indicative of the notification generated at block 610. The output notification may include a visual output, an audio output, or a haptic output. For example, if the notification generated at block 610 is a notification indicating that the XR device is suggested to move towards/closer to the BS for improved communication, then the output notification produced, at block 612, may include the display of text on the XR device stating “Move forward for better performance.”

In cases where operations, depicted at blocks 602-612 in workflow 600, are distributed across two or more devices, then communicating the notification at block 612, may include (1) producing an output notification indicative of the notification generated at block 610 or (2) sending the notification generated at block 610 to the XR device (e.g., where the XR device may produce an output notification indicative of the notification generated at block 610 and sent to the XR device). In response to receiving the notification, the XR device may produce one or more output notifications on the XR device.

For example, in some cases, operations at block 602 and block 604 may not be performed at the XR device. Instead, other wireless device(s) may perform operations at block 602 and block 604 and send the operation information to the XR device. In such cases, the XR device may still perform operations at block 606-612; thus, communication of the notification at block 612 may include producing an output notification indicative of the notification generated at block 610. In some other cases, operations at blocks 602-612 may not be performed at the XR device. Instead, other wireless device(s) may perform operations at blocks 602-612. One of the other wireless device(s) may generate the notification at block 610 and send this notification to the XR device at block 612. As such, communication of the notification at block 612 may include sending the notification, generated block 610, to the XR device. The XR device may generate an output notification indicative of the notification generated at block 610 and sent to the XR device.

In certain aspects, the output notification may be produced at the XR device to trigger a user to perform the action(s) associated with the output notification. For example, the output notification may include two vibrations indicating to a user of the XR device to move left (e.g., prior to performing workflow 600, an association may be created between the action of moving left and the haptic output notification of two vibrations at the XR device). In some cases, the user may follow the action(s) indicated via the output notification. For example, the user may move left after receiving the two vibrations at the XR device.

After producing the output notification on the XR device, workflow 600 returns to block 602 to again perform wireless procedure(s) in the wireless communications environment.

Although workflow 600 describes the generation and communication of a single output notification based on the operation information, in some other examples, multiple output notifications may be generated and communicated based on the operation information. Further, although workflow 600 describes the XR device producing a single output notification based on the notification generated at block 610, in some other examples, multiple output notifications (e.g., a vibration output and a text output, a text output and some audio output, etc.) may be produced by the XR device.

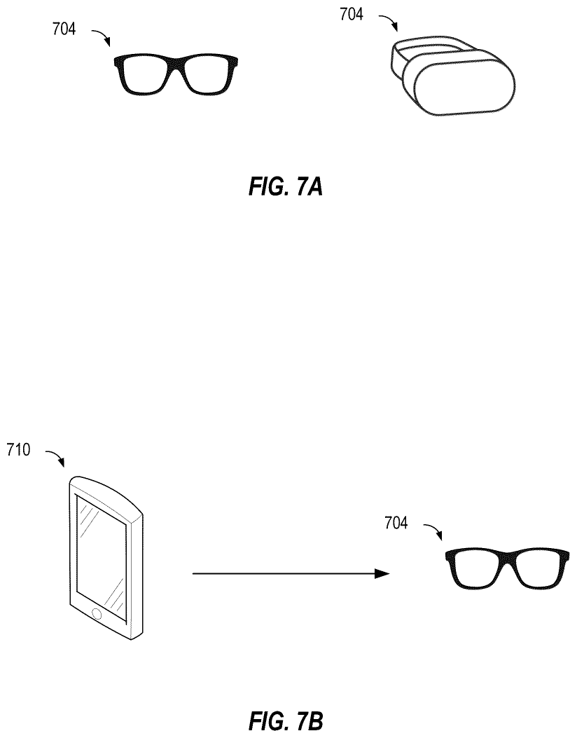

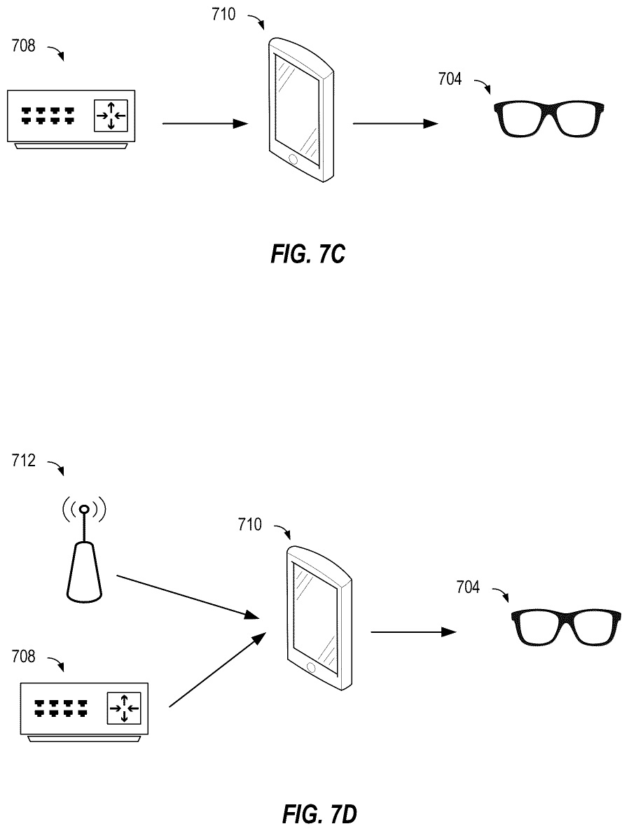

FIGS. 7A-7D depict example options for output notification generation on an XR device. Output notification generation on an XR device may include steps for (1) obtaining operation information (e.g., which includes performing operations at blocks 602 and 604 in workflow 600 of FIG. 6), (2) evaluating the operation information (e.g., which includes performing operations at blocks 606 and 608 in workflow 600 of FIG. 6), and (3) generating one or more output notifications on the XR device based on the evaluation (e.g., which includes performing operations at blocks 610 and 612 in workflow 600 of FIG. 6).

In a first option shown in FIG. 7A, steps (1)-(3) for output notification generation are all performed on a single wireless device, e.g., the XR device 704. The XR device 704 may be or include XR glasses, an XR headset, XR gloves (not shown), XR controllers (not shown), one or more sensors (not shown), an XR BS (not shown), and/or one or more other devices used to help seamlessly merge the physical world with digital. In the first option, the XR device 704 may collect and evaluate operation information for a wireless communications environment where the XR device 704 is operating. Further, the XR device 704 may produce one or more output notification(s), based on the evaluation, which may be used to trigger a user to adjust a wireless connectivity of the XR device 704.

In a second option shown in FIG. 7B, performance of steps (1)-(3) for output notification generation is distributed across two wireless devices. For example, steps (1)-(3) may be performed by a UE 710 (e.g., such as UE 104 of FIGS. 1 and 3) and an XR device 704 (e.g., such as XR glasses). In certain aspects, UE 710 may perform step (1) by obtaining operation information for the wireless communications environment and sending this operation information to XR device 704. XR device 704 may then perform steps (2)-(3) to evaluate the operation information and produce output notification(s) on XR device 704 based on the operation information. In certain other aspects, UE 710 may perform steps (1)-(2) and XR device 704 may perform step (3). For example, UE 710 may obtain and evaluate operation information for the wireless communications environment. UE 710 may generate, based on the operation information, a notification for XR device 704 indicating one or more actions to adjust wireless connectivity of the XR device 704 in the wireless communications environment. UE 710 may send this notification to XR device 704, and XR device 704 may perform step (3) by producing output notification(s) on XR device 704 based on the notification received from UE 710.

In a third option shown in FIG. 7C, performance of steps (1)-(3) for output notification generation is distributed across three wireless devices. For example, steps (1)-(3) may be performed by a wireless AP 708 (e.g., such as a router), a UE 710 (e.g., such as UE 104 of FIGS. 1 and 3), and an XR device 704 (e.g., such as XR glasses). In certain aspects, wireless AP 708 may perform step (1) by obtaining operation information for the wireless communications environment and sending this operation information to XR device 704. The operation information may be sent to XR device 704 via UE 710, which is acting as a relay device. XR device 704 may then perform steps (2)-(3) to evaluate the operation information and produce output notification(s) on XR device 704 based on the operation information. In certain other aspects, wireless AP 708 may perform steps (1)-(2) and XR device 704 may perform step (3). For example, wireless AP 708 may obtain and evaluate operation information for the wireless communications environment. Wireless AP 708 may generate, based on the operation information, a notification for XR device 704 indicating one or more actions to adjust wireless connectivity of XR device 704 in the wireless communications environment. Wireless AP 708 may send this notification to XR device 704 via UE 710, and XR device 704 may perform step (3) based on the notification received from wireless AP 708.

In a fourth option shown in FIG. 7D, performance of steps (1)-(3) for output notification generation is distributed across four wireless devices. For example, steps (1)-(3) may be performed by a BS 712 (e.g., such as BS 102 of FIGS. 1 and 3, or a disaggregated base station as discussed with respect to FIG. 2), a wireless AP 708 (e.g., such as a router), a UE 710 (e.g., such as UE 104 of FIGS. 1 and 3), and an XR device 704 (e.g., such as XR glasses). UE 710 may be connected to both BS 712 and wireless AP 708 (e.g., by having both LTE and WiFi connections).

In certain aspects, BS 712 and wireless AP 708 may perform step (1) by obtaining operation information for the wireless communications environment and sending this operation information to UE 710. In certain aspects, BS 712 and wireless AP 708 may obtain different portions of the operation information for the wireless communications environment. Using this operation information (and in some cases, operation information collected by UE 710 as well), UE 710 may perform step (2) to evaluate the operation information and generate, based on the operation information, a notification for XR device 704. UE 710 may send this notification to XR device 704, and XR device 704 may perform step (3) based on the notification received from UE 710.

In some cases, weights may be applied to the operation information received from BS 712 and wireless AP 708 to create weighted operation information. UE 710 may use this weighted operation information to perform step (2). In certain aspects, the weights applied to the operation information from different wireless devices, such as BS 712 and wireless AP 708, may be configurable (e.g., by a user). In certain aspects, the weights applied to the operation information from different wireless devices, such as BS 712 and wireless AP 708, may be static and/or dynamic. In certain aspects, the weights applied to the operation information from different wireless devices, such as BS 712 and wireless AP 708, may be based on historical data associated with BS 712 and wireless AP 708, respectively. The historical data may include (1) operation information previously collected by BS 712 and/or AP 708 over a period of time and associated with BS 712, AP 708, and/or UE 710 and/or (2) notification(s) previously generated by BS 712, AP 708, and/or UE 710 based on this operation information. For example, UE 710 may store operation information received from BS 712 and AP 708 over a definite period of time (e.g., one hour), as well as notifications generated by UE 710, based on this operation information, during the period of time. UE 710 may use this stored information to identify operation information patterns. Examples of operation information patterns may include changes in wireless measurements over time, increases in latency over time, etc. UE 710 may use these patterns to assign higher weights to operation information later received from BS 712 and/or AP 708 when one or more of these patterns are again observed/present.

In certain aspects, BS 712, wireless AP 708, and UE 710 may each perform steps (1) and (2) to obtain operation information, evaluate the operation information, and generate a notification based on the operation information. For example, BS 712 and wireless AP 708 may each generate and send a notification to UE 710 indicating one or more actions to adjust wireless connectivity of XR device 704 within the wireless communications environment. Using the notifications from BS 712 and wireless AP 708 (and in some cases, a notification generated by UE 710, as well, based on operation information collected for the wireless communications environment), UE 710 may perform step (2) to generate a final notification to send to XR device 704. The final notification may be based on the notification from BS 712, the notification from wireless AP 708, and/or the notification generated by UE 710. For example, the notification from BS 712 may indicate that XR device 704 should move left to adjust wireless connectivity of XR device 704, and the notification from wireless AP 708 may also indicate that XR device 704 should move left to adjust wireless connectivity of XR device 704. The final notification, generated by UE 710, may indicate that XR device 704 should move left based at least in part on the suggested left movement indicated by BS 712 and wireless AP 708. UE 710 may send this final notification to XR device 704, and XR device 704 may perform step (3) based on the final notification received from UE 710.

In some cases, weights may be applied to the notifications received from BS 712 and wireless AP 708 to create weighted notifications. UE 710 may use the weighted notifications to generate the final notification. For example, the notification from BS 712 may indicate that XR device 704 should move left to adjust wireless connectivity of XR device 704. However, the notification from wireless AP 708 may indicate that XR device 704 should move forward (e.g., to be within a geographical boundary where QoS is assured) to adjust wireless connectivity of XR device 704. In determining whether the final notification to XR device 704 should indicate to move left or to move forward, UE 710 may apply weights to the notifications received from BS 712 and wireless AP 708. For example, a 60% weight may be applied to the notification from BS 712 and a 40% weight may be applied to the notification from wireless AP to create weighted notifications. Based on these weighted notifications, the final notification may be generated to indicate that XR device 704 should be moved to the left to adjust wireless connectivity of XR device 704 (e.g., because more weight is given to the notification from BS 712).

In certain aspects, the weights applied to notifications from different wireless devices, such as BS 712 and wireless AP 708, may be configurable (e.g., by a user). In certain aspects, the weights applied to notifications from different wireless devices, such as BS 712 and wireless AP 708, may be static and/or dynamic. In certain aspects, the weights applied to notifications from different wireless devices, such as BS 712 and wireless AP 708, may be based on historical data associated with BS 712 and wireless AP 708, respectively.

It should be noted that the above-described options for output notification generation on an XR device include only a few example options, and other options may be considered. For example, other options may include more or less wireless devices, different types of wireless devices, different device(s) performing different step(s), and/or the like. Further, although FIGS. 7A-7D describe examples where a single output notification is generated at an XR device, in some other examples, multiple output notifications may be generated at the XR device and/or multiple output notifications may be generated at two or more XR devices.

### Example XR Device Output Notifications

FIGS. 8-11, described in detail below, illustrate example XR device output notifications that may be generated according to workflow 600, depicted and described with respect to FIG. 6.

For example, FIG. 8 depicts example generation of an output notification on an XR device 826 (e.g., XR glasses) that may be used to provide directional assistance. More specifically, the output notification may suggest that a user move XR device 826 left or right to adjust wireless connectivity of XR device 826 within a wireless communications environment. Workflow 800 in FIG. 8 may be used to generate this output notification on XR device 826. For example, blocks 802-812 in workflow 800 may be similar to blocks 602-612 in workflow 600 of FIG. 6 used to generate an output notification on an XR device. However, blocks 802-812 may include operations to more specifically generate an output notification that provides specific directional assistance to a user of XR device 826.

In this example illustrated in FIG. 8, operations in workflow 800 are performed by only XR device 826. It is noted, however, in some other examples that performance of the operations in workflow 800 may be distributed across two or more wireless devices.

Workflow 800 begins, at blocks 802 and 804, with XR device 826 performing beam management procedures, such as beam detection and tracking, to obtain one or more beam measurements for a potential beam pair that may be used for communication between a UE 824 (e.g., such as UE 104 of FIGS. 1 and 3) and XR device 826. A beam pair includes a transmit beam used by a transmitter device to transmit a signal to a receiver device, and a receive beam used by the receiver device to receive the signal. For example, UE 824 (e.g., such as UE 104 of FIGS. 1 and 3) may use a transmit beam 828 to send one or more signals to XR device 826. The XR device 826 may use a receive beam (not shown) to receive the one or more signals from UE 824. The transmit beam 828 and the receive beam may form a beam pair between UE 824 and XR device 826. The received signal(s) may be measured at XR device 826 to determine, at least, a reference signal received power (RSRP) (e.g., a beam measurement) for the beam pair.

Workflow 800 then proceeds, at block 806, with XR device 826 processing the beam measurement(s), obtained at block 804, to evaluate the alignment of the transmit beam 828 and the receive beam associated with the beam pair. For example, XR device 826 may analyze the measured RSRP to determine whether there is sufficient alignment between the transmit beam 828 and the receive beam used to communicate the signal(s) between UE 824 and XR device 826.

In this example, as shown in FIG. 8, a directional location of XR device 826 with respect to UE 824 may be different than a directional location of transmit beam 828 used to communicate the signal(s) to XR device 826. As such, an RSRP measured by XR device 826, in this example, may indicate insufficient alignment between the transmit beam 828, used by UE 824, and the receive beam, used by XR device 826, to communicate the signal(s).

Based on the insufficient RSRP, XR device 826 may determine, at block 808, to produce an output notification on XR device 826. For example, to improve communications between UE 824 and XR device 826, including improving, at least, the RSRP at XR device 826, XR device 826 may need to move to the left to better align with the transmit beam 828 used by UE 824 to send signal(s) to XR device 826. To trigger this movement to the left, XR device 826 may determine that an output notification, indicating to move XR device 826 to the left, is needed.

Workflow 800 then proceeds, at block 810, with generating the notification indicating to move XR device 826 to the left (or right in another example). At block 812, XR device 826 communicates the notification generated at 810. For example, XR device 826 may produce an output notification indicative of the notification generated at 810. In certain aspects, the output notification is an audio and/or haptic output indicating to move XR device 826 to the left. In certain aspects, the output notification is a visual output displayed on XR device 826 indicating to move XR device 826 to the left, as shown in FIG. 8.

The output notification may trigger a user of XR device 826 to move XR device 826 to the left to improve connectivity and communication between UE 824 and XR device 826, to help provide a more seamless XR experience at XR device 826.

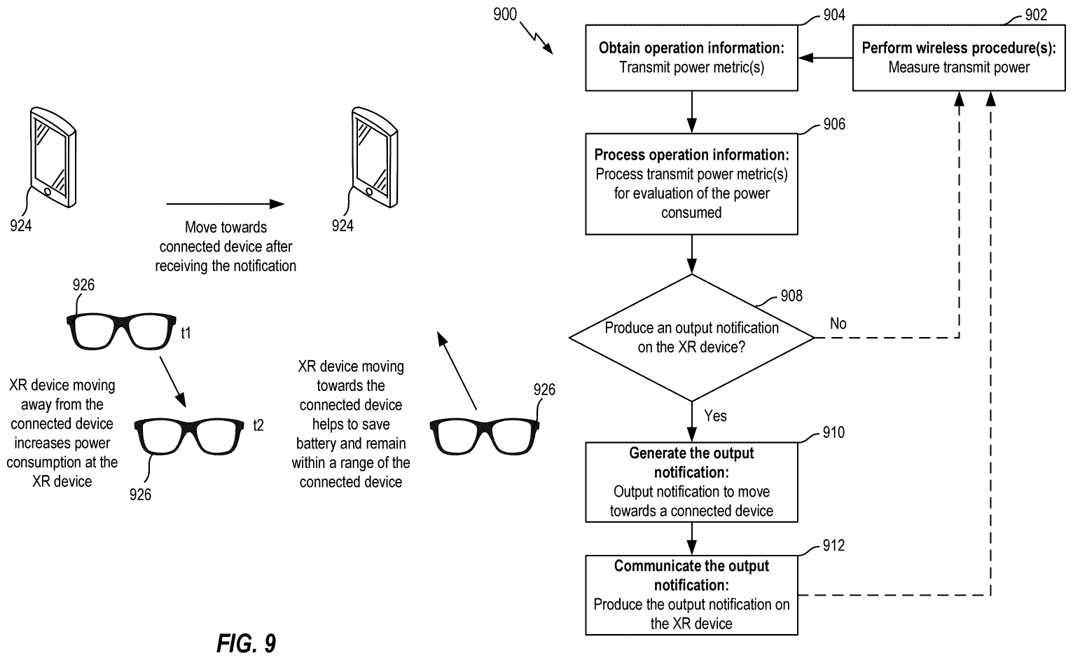

FIG. 9 depicts example generation of an output notification on an XR device 926 (e.g., XR glasses) that may be used to provide positional assistance. More specifically, the output notification may suggest that a user move XR device 926 towards or away from a device connected to XR device 926 to adjust wireless connectivity of XR device 926 within a wireless communications environment. Workflow 900 in FIG. 9 may be used to generate this output notification on XR device 926. For example, blocks 902-912 in workflow 900 may be similar to blocks 602-612 in workflow 600 of FIG. 6 used to generate an output notification on an XR device. However, blocks 902-912 may include operations to more specifically generate an output notification that provides specific positional assistance to a user of XR device 926.

In this example illustrated in FIG. 9, operations in workflow 900 are performed by only XR device 926. It is noted, however, in some other examples, that performance of the operations in workflow 900 may be distributed across two or more wireless devices, including at least XR device 926.

Workflow 900 begins, at blocks 902 and 904, with XR device 926 performing one or more transmit power measurements to obtain transmit power metrics indicative of an amount of power consumed at XR device 926 to transmit data to a UE 924 (e.g., such as UE 104 of FIGS. 1 and 3). For example, XR device 926 may be connected to and communicating with UE 924.

In this example, XR device 926 may obtain the transmit power metrics after XR device 926 has moved away from UE 924. For example, as shown in FIG. 9, at time t1 XR device 926 may be geographically located close to UE 924 (e.g., the connected device). XR device 926 may move away from UE 924 and thus, at time t2, XR device 926 may be a greater distance away from UE 924 than at time t1. For this example, the transmit power measurement(s) may be taken at or after time t2, such that the transmit power metrics represent an amount of power consumed at XR device 926 to transmit data when XR device 926 is a greater distance away from UE 924.

Workflow 900 then proceeds, at block 906, with XR device 926 processing the transmit power metric(s), obtained at block 904, to evaluate the amount of power consumed at XR device 926. For example, XR device 926 may analyze the determined transmit power metric(s) to determine whether the amount of power consumed at XR device 926, to transmit data to UE 924, is greater than a threshold power consumption. In some cases, the threshold power consumption may be based on a battery associated with XR device 926.

In this example, XR device 926 may determine that the threshold power consumption has been surpassed due to, at least, the increased distance between UE 924 and XR device 926. Accordingly, XR device 926 may determine, at block 908, to produce an output notification on XR device 926. For example, to reduce, at least, an amount of power consumed at XR device 926 and thus improve performance of XR device 926, XR device 926 may need to move closer to UE 924 for shorter range communications. To trigger this movement towards UE 924, XR device 926 may determine that an output notification, indicating to move XR device 926 towards UE 924, is needed.

Workflow 900 then proceeds, at block 910, with generating the notification indicating to move XR device 926 towards UE 924. At block 912, XR device 926 communicates the notification generated at 910. For example, XR device 926 may produce an output notification indicative of the notification generated at 910. In certain aspects, the output notification is a visual, audio, and/or haptic output indicating to move XR device 926 towards UE 924.

The output notification may trigger a user of XR device 926 to move XR device 926 towards UE 924 to reduce power consumption at XR device 926 (as well as UE 924), thereby improving overall battery life for XR device 926. Reduced power consumption at XR device 926 may help to improve performance of XR device 926 when providing XR experiences to a user of XR device 926. Further, moving towards UE 924 may help to keep XR device 926 within a range of UE 924 for more reliable and efficient communication between UE 924 and XR device 926.

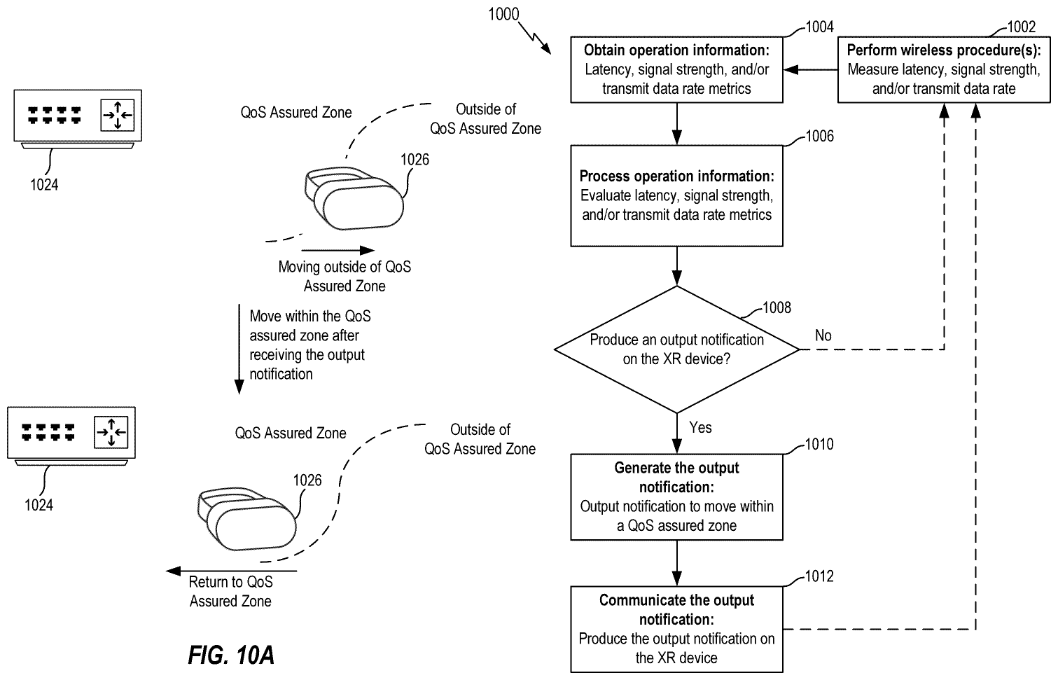

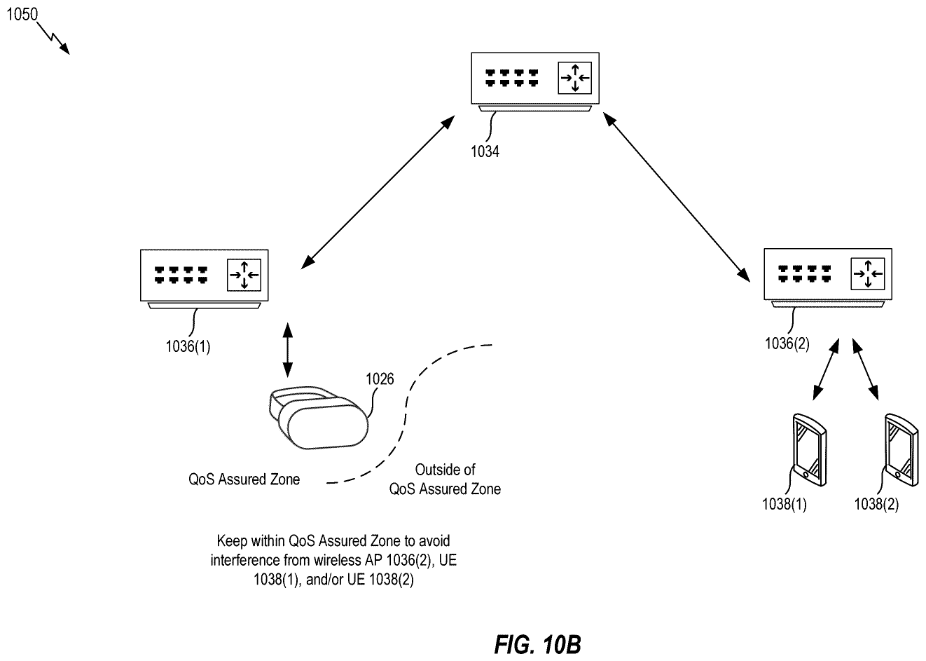

FIGS. 10A-10B depict example generation of output notifications on an XR device 1026 (e.g., XR headset) that may be used to provide geographical fencing assistance. The geographical fencing assistance may be used to help XR device 1026 remain within, and/or relocate to, a position within a QoS assured zone around a wireless device connected to XR device 1026 where QoS requirements for XR device 1026 may be met.

For example, in FIG. 10A, XR device 1026 may be connected to and communicating with a wireless AP 1024. An area surrounding wireless AP 1024 may represent a QoS assured zone where (1) QoS requirements for XR device 1026, including latency, communication reliability, and/or other requirements, may be met and (2) performance of XR device 1026 may be optimized. The QoS assured zone around wireless AP 1024 may be represented by a virtual perimeter built around wireless AP 1024. Part of the virtual perimeter is shown in FIG. 10A as the dashed line. Area outside of the virtual perimeter (e.g., dashed line) is considered area outside of the QoS assured zone.

In FIG. 10A, an output notification generated on XR device 1026 may suggest that a user move XR device 1026 within the QoS assured zone surrounding wireless AP 1024 to adjust wireless connectivity of XR device 1026. Workflow 1000 in FIG. 10A may be used to generate this output notification on XR device 1026. For example, blocks 1002-1012 in workflow 1000 may be similar to blocks 602-612 in workflow 600 of FIG. 6 used to generate an output notification on an XR device. However, blocks 1002-1012 may include operations to more specifically generate an output notification that provides specific geographic fencing assistance to a user of XR device 1026.

In this example illustrated in FIG. 10A, operations in workflow 1000 are performed by only XR device 1026. It is noted, however, in some other examples, that performance of the operations in workflow 1000 may be distributed across two or more wireless devices, including at least XR device 1026.

Workflow 1000 begins, at blocks 1002 and 1004, with XR device 1026 performing one or more of latency, signal strength, and/or transmit data rate measurements to obtain latency, signal strength, and/or transmit data rate metrics for communications between XR device 1026 and wireless AP 1024. In this example, XR device 1026 may obtain such metric(s) after XR device 1026 has moved out of a QoS assured zone surrounding wireless AP 1024 (e.g., as shown in FIG. 10A). For example, a user of XR device 1026 may move XR device 1026 outside of the QoS assured zone. The user may not be aware that XR device 1026 is outside of the QoS assured zone when XR device 1026 is moved.

Workflow 1000 then proceeds, at block 1006, with XR device 1026 evaluating the latency, signal strength, and/or transmit data rate metrics obtained at block 1004. For example, XR device 1026 may analyze the metric(s) to determine whether (1) the measured latency satisfies a threshold latency (e.g., is less than the threshold latency), (2) the measured signal strength satisfies a threshold signal strength (e.g., is greater than the threshold signal strength), and/or (3) the measured transmit data rate satisfies a threshold transmit data rate (e.g., is greater than the threshold transmit data rate). The threshold latency, the threshold signal strength, and/or the threshold transmit data rate may be based on QoS requirements of XR device 1026.

For example, XR device 1026 may require an MPD of less than 20 ms to help ensure that the delay, between when a user of XR device 1026 moves their head and when an image is updated on a display of XR device 1026, does not negatively impact an XR experience generated for the user. This MPD threshold may be used to determine the latency threshold used by XR device 1026 when evaluating latency metrics obtained at block 1008 in workflow 1000.

In this example, XR device 1026 may determine that at least one of the metrics (e.g., measured latency, signal strength, and/or transmit data rate) does not satisfy its respective metric threshold. For example, XR device 1026 may determine that the measured latency is greater than the threshold latency indicating excessive delay in communications between XR device 1026 and wireless AP 1024. Accordingly, XR device 1026 may determine, at block 1008, to produce an output notification on XR device 1026. For example, to, at least, reduce latency between XR device 1026 and wireless AP 1024 and thus improve performance of XR device 1026 (e.g., based on an ability of XR device 1026 to receive data, such as XR content, from wireless AP 1024 more quickly), XR device 1026 may need to return to the QoS assured zone surrounding wireless AP 1024. To trigger this movement of XR device 1026 within the geographical boundary of the QoS assured zone, XR device 1026 may determine that an output notification, indicating to move XR device 1026 to a position within the QoS assured zone, is needed.

Workflow 1000 then proceeds, at block 1010, with generating the notification indicating to move XR device 1026 within the QoS assured zone. Because a user of XR device 1026 may be unaware of where the QoS assured zone is located and its geographical boundary, in some cases, the notification may indicate to move XR device 1026 to a particular location, and that particular location may be located within the QoS assured zone. In some other cases, the notification may indicate to move XR device 1026 forward, backward, to the left, to the right, etc. such that XR device 1026 is moved within the QoS assured zone.

At block 1012, XR device 1026 communicates the notification generated at 1010. For example, XR device 826 may produce an output notification indicative of the notification generated at 1010. In certain aspects, the output notification is a visual, audio, and/or haptic output indicating to move XR device 1026 within the QoS assured zone.

The output notification may trigger a user of XR device 1026 to move XR device 1026 within the QoS assured zone to help ensure that latency experienced by XR device 1026 when communicating with wireless AP 1024 does not impact an XR experience at XR device 1026.

Similar to FIG. 10A, FIG. 10B depicts example generation of an output notification on XR device 1026 (e.g., an XR headset) that may be used to help XR device 1026 remain within, and/or relocate to, a position within a QoS assured zone around a wireless device connected to XR device 1026. However, unlike FIG. 10A where the decision to generate the output notification is determined by XR device 1026, in FIG. 10B, generation of the output notification on XR device 1026 is determined by a wireless device other than XR device 1026.

For example, XR device 1026 is connected to and communicating with a wireless AP 1036(1). Wireless AP 1036(1) may be connected to a WLAN controller 1034, which is also connected to another wireless AP 1036(2). Wireless AP 1036(2) may be further connected to and communicating with two UEs (e.g., UE 1038(1) and UE 1038(2)). WLAN controller 1034 may obtain information about both wireless AP 1036(1) and wireless AP 1036(2). The information may indicate a number of wireless devices connected to each wireless AP, a data rate between the wireless device(s) and each wireless AP, a latency between the wireless device(s) and each wireless AP, etc. WLAN controller 1034 may use this information to perform load balancing between wireless AP 1036(1) and wireless AP 1036(2).

For example, in FIG. 10B, WLAN controller 1034 may determine that a traffic load at wireless AP 1036(2) is greater than a network capacity of wireless AP 1036(2) (e.g., network congestion is present at wireless AP 1036(2)) based on low transmission data rates between UEs 1038(1), 1038(2) and wireless AP 1036(2). As such, WLAN controller 1034 may determine that XR device 1026 may have a better connection to wireless AP 1036(1) than wireless AP 1036(2). To enhance the connection between wireless AP 1036(1) and XR device 1026, WLAN controller 103 may generate a notification suggesting that XR device 1026 remain within the QoS assured zone of wireless AP 1036(1) to avoid any interference caused by wireless AP 1036(2), UE 1038(1), and/or UE 1038(2).

WLAN controller 1034 may send this notification to XR device 1026 via wireless AP 1036(1) (e.g., acting as a relay device). In response to receiving this notification, XR device 1026 may produce one or more output notifications on XR device 1026. The output notification(s) may be used to indicate one or more actions, including for example, an action to stay within the QoS assured zone associated with wireless AP 1036(1) and/or an action to move within the QoS assured zone.

The output notification(s) may trigger a user of XR device 1026 to move XR device 1026 and/or maintain a geographical location of XR device 1026 within the QoS assured zone.

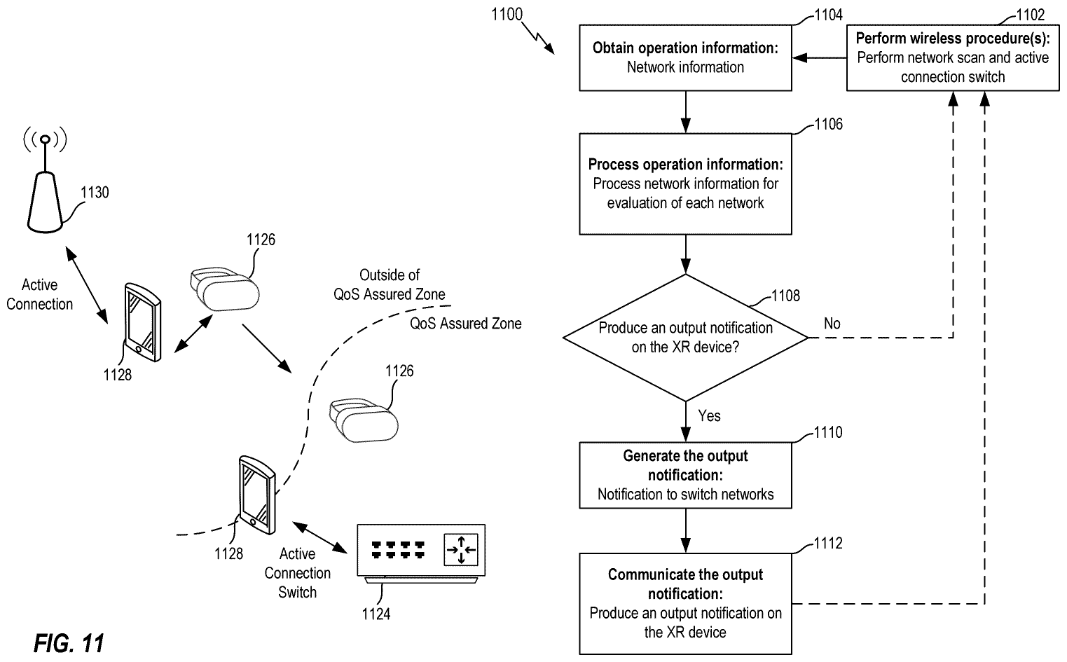

FIG. 11 depicts example generation of an output notification on an XR device 1126 (e.g., an XR headset) that may be used to provide network selection assistance. More specifically, the output notification may suggest that a user switch wireless communications networks to adjust wireless connectivity of XR device 1126. Workflow 1100 in FIG. 11 may be used to generate this output notification on XR device 1126. For example, blocks 1102-1112 in workflow 1100 may be similar to blocks 602-612 in workflow 600 of FIG. 6 used to generate an output notification on an XR device. However, blocks 1102-1112 may include operations to more specifically generate an output notification that provides specific network selection assistance to a user of XR device 1126.

In this example illustrated in FIG. 11, operations in workflow 1100 are performed by a UE 1128 (e.g., such as UE 104 of FIGS. 1 and 3). UE 1128 may have parallel connectivity to a BS 1130 and a wireless AP 1124 (e.g., UE 1128 may have cellular and WiFi coverage). UE 1128 may also be connected to and communicating with XR device 1126 when an active connection of UE 1128 is established between UE 1128 and BS 1130 (e.g., XR device 1126 may also be connected to and communicating with BS 1130).

Although workflow 1100 describes operations performed by UE 1128, it is noted that in some other examples, performance of the operations in workflow 1100 may be distributed across two or more wireless devices.

In workflow 1100, UE 1128 may have an active connection with BS 1130. Using this connection, UE 1128 may perform, at block 1102, a network scan to obtain network information for the cellular network including BS 1130. Further, UE 1128 may perform, at block 1102, a network switch to switch an active connection of XR device. For example, UE 1128 may establish an active connection between UE 1128 and wireless AP 1124. Using this connection, UE 1128 may perform, at block 1102, a network scan to obtain network information for the cellular network including BS 1130. Thus, at block 1104, UE 1128 may obtain network information about (1) the cellular network including BS 1130 and (2) the WiFi-enabled network including wireless AP 1124.

Workflow 1100 then proceeds, at block 1106, with UE 1128 processing the network information to evaluate the performance of each network. For example, UE 1128 may process the network information to determine a network availability of the cellular network and the WiFi-enabled network. As used herein, network availability may refer to a measure of how well a network can respond to connectivity and performance demands placed on it.

In this example, UE 1128 may determine that the WiFi-enabled network provides better network availability than the cellular network. Accordingly, UE 1128 may determine, at block 1108, to produce an output notification on XR device 1126 suggesting that XR device 1126 switch from the cellular network to the WiFi-enabled network. For example, to improve a connectivity of XR device 1126, XR device 1126 may switch to using WiFi communications to communicate XR traffic (e.g., instead of using cellular communications). To trigger this switch, UE 1128 may determine that an output notification, indicating that XR device 1126 should switch to using WiFi communications, is needed.

Workflow 1100 then proceeds, at block 1110, with generating the notification indicating to switch to using WiFi communications. At block 1112, UE 1128 communicates the notification generated at 1110. For example, UE 1128 may send the notification to XR device 1126.

In response to receiving this notification, XR device 1126 may produce one or more output notifications on XR device 1126. The output notification(s) may be used to indicate one or more actions, including for example, an action to switch to using WiFi communications instead of cellular communication (e.g., switch from LTE to WiFi). The output notification(s) may trigger a user of XR device 1126 to initiate a WiFi connection for XR device 1126.

### Example Operations

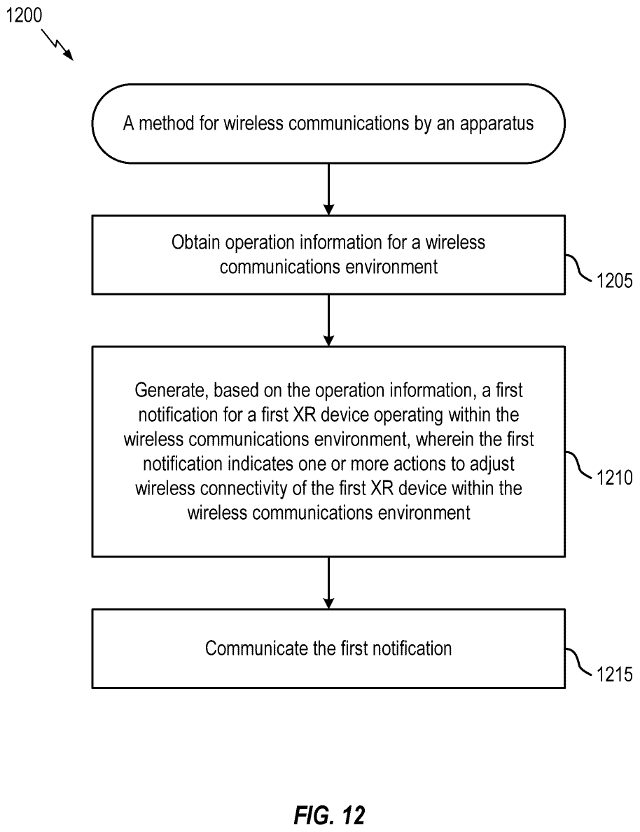

FIG. 12 shows a method 1200 of wireless communications by an apparatus, for example, such as UE 104 of FIGS. 1 and 3, BS 102 of FIGS. 1 and 3, a disaggregated base station discussed with respect to FIG. 2, an XR Device, a wireless AP, a wireless STA, a Bluetooth-enabled device, a WLAN controller, one or more intermediary RAN elements, or one or more cloud network elements.

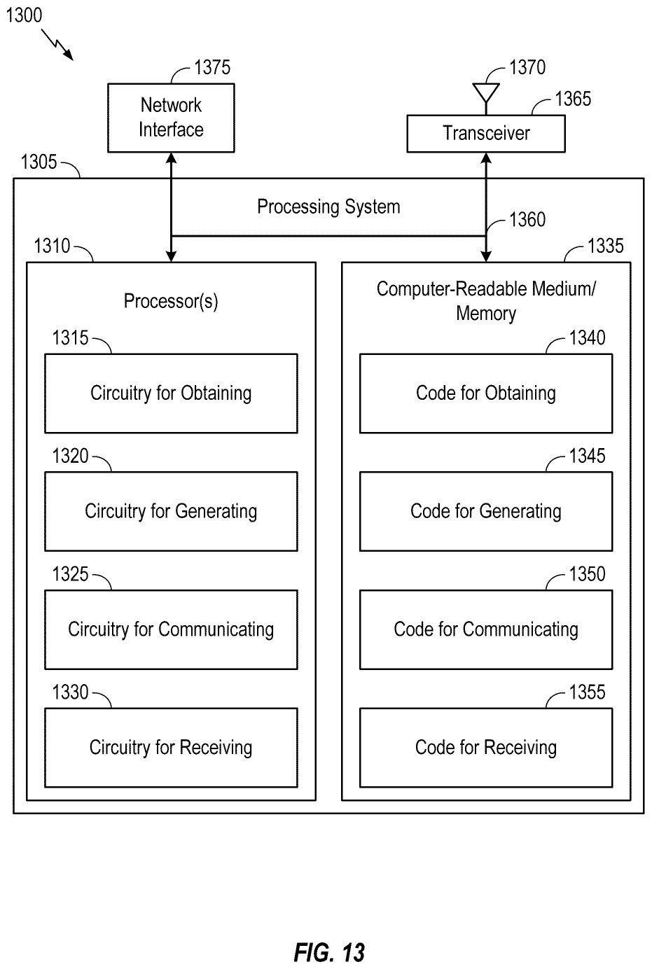

Method 1200 begins at block 1205 with obtaining operation information for a wireless communications environment. For example, the apparatus (e.g., using the transceivers 332, transceivers 354, antenna(s) 334, antenna(s) 352, receive processor 338, receive processor 358, controller/processor 340, and/or controller/processor 380 illustrated in FIG. 3; one or more transceivers 1365, one or more antennas 1370, and/or one or more network interfaces 1375 in FIG. 13; one or more processing systems 1305 in FIG. 13; and/or one or more elements of the one or more processing systems 1305 in FIG. 13) may obtain operation information for a wireless communications environment. The apparatus may obtain the operation information in a manner similar to that described above, such as at 604 in FIG. 6, at 804 in FIG. 8, 904 in FIG. 9, 1004 in FIG. 10A, and/or 1104 in FIG. 11.

Method 1200 then proceeds to block 1210 with generating, based on the operation information, a first notification for a first XR device operating within the wireless communications environment. For example, the apparatus (e.g., using the controller/processor 340 and/or controller/processor 380 illustrated in FIG. 3; one or more processing systems 1305 in FIG. 13; and/or one or more elements of the one or more processing systems 1305 in FIG. 13) may generate the first notification for the first XR device. The apparatus may the first notification for the first XR device in a manner similar to that described above, such as at 610 in FIG. 6, at 810 in FIG. 8, 910 in FIG. 9, 1010 in FIG. 10A, and/or 1110 in FIG. 11. The first notification may indicate one or more actions to adjust wireless connectivity of the first XR device within the wireless communications environment.

Method 1200 then proceeds to block 1215 with communicating the first notification. For example, the apparatus (e.g., using the transceivers 332, transceivers 354, antenna(s) 334, antenna(s) 352, transmit processor 320, transmit processor 364, TX MIMO processor 330, TX MIMO processor 366, controller/processor 340, and/or controller/processor 380 illustrated in FIG. 3; one or more transceivers 1365, one or more antennas 1370, and/or one or more network interfaces 1375 in FIG. 13; one or more processing systems 1305 in FIG. 13; and/or one or more elements of the one or more processing systems 1305 in FIG. 13) may communicate the first information. The apparatus may communicate the first notification in a manner similar to that described above, such as 612 in FIG. 6, at 812 in FIG. 8, 912 in FIG. 9, 1012 in FIG. 10A, and/or 1112 in FIG. 11. In certain aspects, the apparatus comprises the first XR device; and block 1215 includes producing an output notification indicative of the first notification at the apparatus.

In certain aspects, the output notification comprises at least one of: a visual output; an audio output; or a haptic output.

In certain aspects, the apparatus comprises: a second XR device; a UE; a BS; a wireless AP; a wireless STA; a Bluetooth-enabled device; a WLAN controller; one or more intermediary RAN elements; or one or more cloud network elements.

In certain aspects, block 1215 includes sending the first notification to the first XR device.

In certain aspects, sending the first notification to the first XR device comprises sending the first notification to the first XR device via a relay device.

In certain aspects, block 1215 includes sending the first notification to another device.

In certain aspects, block 1205 includes taking one or more measurements within the wireless communications environment.

In certain aspects, block 1205 includes receiving the operation information from one or more devices operating within the wireless communications environment.

In certain aspects, block 1210 includes: comparing at least part of the operation information to at least one threshold; and generating the first notification based on the at least the part of the operation information satisfying the at least one threshold.

In certain aspects, method 1200 further includes receiving a second notification from a device operating within the wireless communications environment; and block 1210 includes generating the first notification further based on the second notification.

In certain aspects, method 1200 further includes receiving a plurality of second notifications from a plurality of devices operating within the wireless communications environment; and block 1210 includes: generating a third notification for the first XR device based on the operation information; applying a respective weight to each of the plurality of second notifications and the third notification to create weighted notifications; and generating the first notification based on the weighted notifications.

In certain aspects, the operation information comprises at least one of: one or more channel measurements; one or more interference measurements; one or more transmission data rates; one or more packet error rates; one or more power measurements; network availability information; latency information; operating band information; signal strength information; frequency hopping co-existence information; beam tracking information; a power state of the XR device; or information about pending data for transmission.

In certain aspects, the one or more actions comprise at least one of: to move in a direction; to move to a position; to stay in a geographical boundary; or to select a connectivity technology.

In certain aspects, the operation information comprises beam tracking information, and the one or more actions comprise to move in a left direction or in a right direction.

In certain aspects, the operation information comprises one or more transmit power metrics for the first XR device based on communications between the first XR device and the apparatus, and the one or more actions comprise to move towards the apparatus.

In certain aspects, the XR device is geographically located outside of a geographical boundary associated with the apparatus; the operation information comprises at least one of: one or more transmission data rates; latency information; or signal strength information, and the one or more actions comprise to move within the geographical boundary.

In certain aspects, the operation information comprises network availability information for two or more wireless communications networks, and the one or more actions comprise to select a connectivity technology associated with a first wireless communications network of the two or more wireless communications networks.

In certain aspects, method 1200, or any aspect related to it, may be performed by an apparatus, such as communications device 1300 of FIG. 13, which includes various components operable, configured, or adapted to perform the method 1200. Communications device 1300 is described below in further detail.

Note that FIG. 12 is just one example of a method, and other methods including fewer, additional, or alternative operations are possible consistent with this disclosure.

### Example Communications Device

FIG. 13 depicts aspects of an example communications device 1300. In some aspects, communications device 1300 is a user equipment, such as UE 104 described above with respect to FIGS. 1 and 3. In some aspects, communications device 1300 is a network entity, such as BS 102 of FIGS. 1 and 3, or a disaggregated base station as discussed with respect to FIG. 2. In some aspects, communications device 1300 is an XR Device, AP, STA, Bluetooth-enabled device, WLAN controller, one or more intermediary RAN elements, or one or more cloud network elements.

The communications device 1300 includes a processing system 1305 coupled to a transceiver 1365 (e.g., a transmitter and/or a receiver) and/or a network interface 1375. The transceiver 1365 is configured to transmit and receive signals for the communications device 1300 via an antenna 1370, such as the various signals as described herein. The network interface 1375 is configured to obtain and send signals for the communications device 1300 via communications link(s), such as a backhaul link, midhaul link, and/or fronthaul link as described herein, such as with respect to FIG. 2. The processing system 1305 may be configured to perform processing functions for the communications device 1300, including processing signals received and/or to be transmitted by the communications device 1300.

The processing system 1305 includes one or more processors 1310. In various aspects, the one or more processors 1310 may be representative of one or more of receive processor 338, receive processor 358, transmit processor 320, transmit processor 364, TX MIMO processor 330, TX MIMO processor 366, controller/processor 340, and/or controller/processor 380, as described with respect to FIG. 3. The one or more processors 1310 are coupled to a computer-readable medium/memory 1335 via a bus 1360. In certain aspects, the computer-readable medium/memory 1335 is configured to store instructions (e.g., computer-executable code) that when executed by the one or more processors 1310, enable and cause the one or more processors 1310 to perform the method 1200 described with respect to FIG. 12, or any aspect related to it, including any operations described in relation to FIG. 12. Note that reference to a processor performing a function of communications device 1300 may include one or more processors performing that function of communications device 1300, such as in a distributed fashion.

In the depicted example, computer-readable medium/memory 1335 stores code for obtaining 1340, code for generating 1345, code for communicating 1350, and code for receiving 1355. Processing of the code 1340-1355 may enable and cause the communications device 1300 to perform the method 1200 described with respect to FIG. 12, or any aspect related to it.

The one or more processors 1310 include circuitry configured to implement (e.g., execute) the code stored in the computer-readable medium/memory 1335, including circuitry for obtaining 1315, circuitry for generating 1320, circuitry for communicating 1325, and circuitry for receiving 1330. Processing with circuitry 1315-1330 may enable and cause the communications device 1300 to perform the method 1200 described with respect to FIG. 12, or any aspect related to it.

More generally, means for communicating, transmitting, sending or outputting for transmission may include: the transceivers 332, antenna(s) 334, transmit processor 320, TX MIMO processor 330, AI processor 318, and/or controller/processor 340 of the BS 102 illustrated in FIG. 3; the transceivers 354, antenna(s) 352, transmit processor 364, TX MIMO processor 366, AI processor 370, and/or controller/processor 380 of the UE 104 illustrated in FIG. 3; transceiver 1365, antenna 1370, and/or network interface 1375 of the communications device 1300 in FIG. 13; and/or one or more processors 1310 of the communications device 1300 in FIG. 13. Means for communicating, receiving or obtaining may include: the transceivers 332, antenna(s) 334, receive processor 338, AI processor 318, and/or controller/processor 340 of the BS 102 illustrated in FIG. 3; the transceivers 354, antenna(s) 352, receive processor 358, AI processor 370, and/or controller/processor 380 of the UE 104 illustrated in FIG. 3; transceiver 1365, antenna 1370, and/or network interface 1375 of the communications device 1300 in FIG. 13; and/or one or more processors 1304 of the communications device 1300 in FIG. 13.

### Example Clauses

Implementation examples are described in the following numbered clauses:

Clause 1: A method for wireless communications by an apparatus comprising: obtaining operation information for a wireless communications environment; generating, based on the operation information, a first notification for a first XR device operating within the wireless communications environment, wherein the first notification indicates one or more actions to adjust wireless connectivity of the first XR device within the wireless communications environment; and communicating the first notification.

Clause 2: The method of Clause 1, wherein: the apparatus comprises the first XR device; and communicating the first notification comprises producing an output notification indicative of the first notification at the apparatus.

Clause 3: The method of Clause 2, wherein the output notification comprises at least one of: a visual output; an audio output; or a haptic output.

Clause 4: The method of any one of Clauses 1-3, wherein the apparatus comprises: a second XR device; a UE; a BS; a wireless AP; a wireless STA; a Bluetooth-enabled device; a WLAN controller; one or more intermediary RAN elements; or one or more cloud network elements.

Clause 5: The method of Clause 4, wherein communicating the first notification comprises sending the first notification to the first XR device.

Clause 6: The method of Clause 5, wherein sending the first notification to the first XR device comprises sending the first notification to the first XR device via a relay device.

Clause 7: The method of Clause 4, wherein communicating the first notification comprises sending the first notification to another device.

Clause 8: The method of any one of Clauses 1-7, wherein obtaining the operation information comprises taking one or more measurements within the wireless communications environment.

Clause 9: The method of any one of Clauses 1-8, wherein obtaining the operation information comprises receiving the operation information from one or more devices operating within the wireless communications environment.

Clause 10: The method of any one of Clauses 1-9, wherein generating the first notification comprises: comparing at least part of the operation information to at least one threshold; and generating the first notification based on the at least the part of the operation information satisfying the at least one threshold.

Clause 11: The method of any one of Clauses 1-10, further comprising receiving a second notification from a device operating within the wireless communications environment; and generating the first notification comprises generating the first notification further based on the second notification.

Clause 12: The method of any one of Clauses 1-11, further comprising receiving a plurality of second notifications from a plurality of devices operating within the wireless communications environment; and generating the first notification comprises: generating a third notification for the first XR device based on the operation information; applying a respective weight to each of the plurality of second notifications and the third notification to create weighted notifications; and generating the first notification based on the weighted notifications.

Clause 13: The method of any one of Clauses 1-12, wherein the operation information comprises at least one of: one or more channel measurements; one or more interference measurements; one or more transmission data rates; one or more packet error rates; one or more power measurements; network availability information; latency information; operating band information; signal strength information; frequency hopping co-existence information; beam tracking information; a power state of the XR device; or information about pending data for transmission.

Clause 14: The method of any one of Clauses 1-13, wherein the one or more actions comprise at least one of: to move in a direction; to move to a position; to stay in a geographical boundary; or to select a connectivity technology.

Clause 15: The method of any one of Clauses 1-14, wherein: the operation information comprises beam tracking information, and the one or more actions comprise to move in a left direction or in a right direction.

Clause 16: The method of any one of Clauses 1-15, wherein: the operation information comprises one or more transmit power metrics for the first XR device based on communications between the first XR device and the apparatus, and the one or more actions comprise to move towards the apparatus.

Clause 17: The method of any one of Clauses 1-16, wherein: the XR device is geographically located outside of a geographical boundary associated with the apparatus; the operation information comprises at least one of: one or more transmission data rates; latency information; or signal strength information, and the one or more actions comprise to move within the geographical boundary.

Clause 18: The method of any one of Clauses 1-17, wherein: the operation information comprises network availability information for two or more wireless communications networks, and the one or more actions comprise to select a connectivity technology associated with a first wireless communications network of the two or more wireless communications networks.

Clause 19: One or more apparatuses, comprising: one or more memories comprising executable instructions; and one or more processors configured to execute the executable instructions and cause the one or more apparatuses to perform a method in accordance with any one of Clauses 1-18.

Clause 20: One or more apparatuses, comprising: one or more memories; and one or more processors, coupled to the one or more memories, configured to cause the one or more apparatuses to perform a method in accordance with any one of Clauses 1-18.

Clause 21: One or more apparatuses, comprising: one or more memories; and one or more processors, coupled to the one or more memories, configured to perform a method in accordance with any one of Clauses 1-18.

Clause 22: One or more apparatuses, comprising means for performing a method in accordance with any one of Clauses 1-18.

Clause 23: One or more non-transitory computer-readable media comprising executable instructions that, when executed by one or more processors of one or more apparatuses, cause the one or more apparatuses to perform a method in accordance with any one of Clauses 1-18.

Clause 24: One or more computer program products embodied on one or more computer-readable storage media comprising code for performing a method in accordance with any one of Clauses 1-18.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising:
one or more memories; and
one or more processors coupled to the one or more memories, the one or more processors being configured to cause the apparatus to:
obtain operation information for a wireless communications environment;
generate, based on the operation information, a first notification for a first extended reality (XR) device operating within the wireless communications environment, wherein the first notification indicates one or more actions to adjust wireless connectivity of the first XR device within the wireless communications environment; and
communicate the first notification.

2. The apparatus of claim 1, wherein:
the apparatus comprises the first XR device; and
to communicate the first notification, the one or more processors are configured to cause the apparatus to produce an output notification indicative of the first notification at the apparatus.

3. The apparatus of claim 2, wherein the output notification comprises at least one of:
a visual output;
an audio output; or
a haptic output.

4. The apparatus of claim 1, wherein the apparatus comprises:
a second XR device;
a user equipment (UE);
a base station (BS);
a wireless access point (AP);
a wireless station (STA);
a Bluetooth-enabled device;
a wireless local area network (WLAN) controller;
one or more intermediary radio access network (RAN) elements; or
one or more cloud network elements.

5. The apparatus of claim 4, wherein to communicate the first notification, the one or more processors are configured to cause the apparatus to send the first notification to the first XR device.

6. The apparatus of claim 5, wherein to send the first notification to the first XR device, the one or more processors are configured to cause the apparatus to send the first notification to the first XR device via a relay device.

7. The apparatus of claim 4, wherein to communicate the first notification, the one or more processors are configured to cause the apparatus to send the first notification to another device.

8. The apparatus of claim 1, wherein to obtain the operation information, the one or more processors are configured to cause the apparatus to take one or more measurements within the wireless communications environment.

9. The apparatus of claim 1, wherein to obtain the operation information, the one or more processors are configured to cause the apparatus to receive the operation information from one or more devices operating within the wireless communications environment.

10. The apparatus of claim 1, wherein to generate the first notification, the one or more processors are configured to cause the apparatus to:
compare at least part of the operation information to at least one threshold; and
generate the first notification based on the at least the part of the operation information satisfying the at least one threshold.

11. The apparatus of claim 1, wherein:
the one or more processors are configured to cause the apparatus to receive a second notification from a device operating within the wireless communications environment; and
to generate the first notification, the one or more processors are configured to cause the apparatus to generate the first notification further based on the second notification.

12. The apparatus of claim 1, wherein:
the one or more processors are configured to cause the apparatus to receive a plurality of second notifications from a plurality of devices operating within the wireless communications environment; and
to generate the first notification, the one or more processors are configured to cause the apparatus to:
generate a third notification for the first XR device based on the operation information;
apply a respective weight to each of the plurality of second notifications and the third notification to create weighted notifications; and
generate the first notification based on the weighted notifications.

13. The apparatus of claim 1, wherein the operation information comprises at least one of:
one or more channel measurements;
one or more interference measurements;
one or more transmission data rates;
one or more packet error rates;
one or more power measurements;
network availability information;
latency information;
operating band information;
signal strength information;
frequency hopping co-existence information;
beam tracking information;
a power state of the XR device; or
information about pending data for transmission.

14. The apparatus of claim 1, wherein the one or more actions comprise at least one of:
to move in a direction;
to move to a position;
to stay in a geographical boundary; or
to select a connectivity technology.

15. The apparatus of claim 1, wherein:
the operation information comprises beam tracking information, and
the one or more actions comprise to move in a left direction or a right direction.

16. The apparatus of claim 1, wherein:
the operation information comprises one or more transmit power metrics for the first XR device based on communications between the first XR device and the apparatus, and
the one or more actions comprise to move towards the apparatus.

17. The apparatus of claim 1, wherein:
the XR device is geographically located outside of a geographical boundary associated with the apparatus;
the operation information comprises at least one of:
one or more transmission data rates;
latency information; or
signal strength information, and
the one or more actions comprise to move within the geographical boundary.

18. The apparatus of claim 1, wherein:
the operation information comprises network availability information for two or more wireless communications networks, and
the one or more actions comprise to select a connectivity technology associated with a first wireless communications network of the two or more wireless communications networks.

19. A method for wireless communications by an apparatus comprising:
obtaining operation information for a wireless communications environment;
generating, based on the operation information, a first notification for a first extended reality (XR) device operating within the wireless communications environment, wherein the first notification indicates one or more actions to adjust wireless connectivity of the first XR device within the wireless communications environment; and
communicating the first notification.

20. One or more non-transitory computer-readable media comprising executable instructions that, when executed by one or more processors of an apparatus, cause the apparatus to perform operations comprising:
obtaining operation information for a wireless communications environment;
generating, based on the operation information, a first notification for a first extended reality (XR) device operating within the wireless communications environment, wherein the first notification indicates one or more actions to adjust wireless connectivity of the first XR device within the wireless communications environment; and
communicating the first notification.
